(19) United States
(12) Patent Application Publication
(10) Pub. No.: US 2025/0003277 A1
(43) Pub. Date: Jan. 2, 2025

(54) PERMANENT MAGNET ARRANGEMENT, AXIAL FLUX MACHINE AND ELECTROMECHANICAL DRIVE

(71) Applicant: dormakaba Deutschland GmbH, Ennepetal (DE)

(72) Inventors: Sven Busch, Dortmund (DE); Tim Mertens, Wuppertal (DE); Jan Eric vom Brocke, Ennepetal (DE)

(21) Appl. No.: 18/752,256

(22) Filed: Jun. 24, 2024

(30) Foreign Application Priority Data
Jun. 27, 2023 (EP) 23181709.9

(51) Int. Cl. E05F 15/603; H02K 1/14; H02K 21/24; H02K 21/34

(52) U.S. Cl. CPC E05F 15/603; H02K 1/145; H02K 21/24; H02K 21/34; E05Y 2201/434; E05Y 2201/46

(57) ABSTRACT

A permanent magnet arrangement for use as a rotor or stator of an axial flux machine, in particular an axial flux machine of a door drive includes. permanent magnets arranged in a ring-shaped manner around a central axis and each magnetised in an axial direction running parallel to the central axis. Permanent magnets arranged adjacent to each other each have an opposite polarisation. All permanent magnets are configured in one piece and form a multi-pole pair ring magnet.

### CROSS-REFERENCE TO RELATED APPLICATIONS

This application claims the benefit of European patent application 23181709.9, filed on 27 Jun. 2023, the disclosure of which is incorporated herein by reference in its entirety.

### TECHNICAL FIELD

The disclosure relates to a permanent magnet arrangement for use as a rotor or stator of an axial flux machine, in particular an axial flux machine of a door drive, with the permanent magnet arrangement having a plurality of permanent magnets arranged in a ring-shaped manner around a central axis and each magnetised in an axial direction running parallel to the central axis, and with permanent magnets arranged adjacent to one another each having an opposite polarisation. The disclosure also relates to an axial flux machine with a coil arrangement and a permanent magnet arrangement as well as an electromechanical drive.

### BACKGROUND

The use of axial flux machines and in particular of brushless axial flux machines for door drives is known from the prior art and is described, for example, in the document EP 3 974 610 A1. In such axial flux machines, the magnetic flux runs through the permanent magnet arrangement and the coil arrangement axially to the axis of rotation of the motor, which forms the machine axis. The permanent magnet arrangement forms part of a stator of the axial flux machine and the coil arrangement forms part of a rotor of the axial flux machine or the permanent magnet arrangement forms part of the rotor of the axial flux machine and the coil arrangement forms part of the stator of the axial flux machine. The permanent magnets of the permanent magnet arrangement and coils of the coil arrangement are thereby usually arranged in a ring-shaped manner around the machine axis. The permanent magnets are aligned such that one of the poles of each permanent magnet is closer to the coil arrangement than the other pole, such that within the respective permanent magnet, magnetic field lines running between the north pole and the south pole run parallel to the machine axis. The permanent magnets usually have an approximately trapezoidal base surface, with dimensions of the base surface being a multiple of the height of the respective permanent magnet. Straight lines through side edges of the base surface thereby usually run through a point on the axis of rotation or the machine axis, such that an inner edge of the base surface is shorter than an outer edge of the base surface. The permanent magnets therefore have the shape of an approximately trapezoidal prism. Often the inner edge and the outer edge are also designed in a circular segment shape, such that the base surface forms a ring segment.

To manufacture the permanent magnet arrangements known from the prior art, individual permanent magnets of the permanent magnet arrangement are usually aligned on a carrier plate and, for example, attached to the carrier plate by adhesive. The height of the permanent magnet arrangement thereby corresponds to the height of the carrier plate plus the height of the permanent magnets.

### SUMMARY

The disclosure improves the permanent magnet arrangements known from the prior art.

This is achieved according to the disclosure by providing at least two permanent magnets arranged adjacent to one another are configured in one piece. In this way, the effort involved in manufacturing the permanent magnet arrangements can be reduced, since fewer individual permanent magnets have to be attached to the carrier plate. A plurality of permanent magnets can thereby be configured in one piece by using a powder metallurgy process for manufacture, with a weak magnetic field being applied at the same time as the powdered starting material is pressed, thereby specifying a preferred polarisation, which is usually defined radially or axially. The blanks manufactured in this way are then magnetised in a magnetisation device by strong magnetic fields of different or opposite polarisation in regions of the blank arranged adjacent to one another. This different polarisation is reproduced by the powder particles of the starting material and frozen or stored in the magnetic material manufactured in this way.

In order to further reduce the manufacturing effort for the permanent magnet arrangement, it is provided according to the disclosure that all permanent magnets are configured in one piece with one another and form a multi-pole pair ring magnet. The configuration as a multi-pole pair ring magnet offers the additional advantage when used according to the disclosure as a permanent magnet arrangement for a stator or rotor of an axial flux machine that the carrier plate can be dispensed with if necessary, such that less installation space is required for the stator or rotor. In addition, the permanent magnet arrangement in this configuration can advantageously have continuously flat surfaces or side surfaces according to the disclosure, whereby a more uniform run is achieved, for example when used as a rotor. When configured with continuously flat surfaces, the individual permanent magnets can no longer be visually distinguished from one another. Therefore, in the sense of this disclosure, the various permanent magnets of the permanent magnet arrangement are separated from one another by reversing the direction of the magnetic flux density generated by the permanent magnet arrangement between two adjacently arranged permanent magnets. One form of the permanent magnets is thereby determined by the magnetic flux density which is generated within the ring magnet by the permanent magnet and which drops to zero at the sides of the respective permanent magnet, with the side surfaces of the permanent magnet being predetermined by this drop to zero. The top and bottom side of the respective permanent magnets are determined by the top and bottom side of the ring magnet.

Advantageously, it is provided according to the disclosure that an unmagnetised region is provided between each two permanent magnets arranged adjacent to one another, with the unmagnetised region being designed in one piece with the permanent magnets. In this way, the manufacturing process of the one-piece permanent magnets can be simplified, since the external magnetic fields applied during magnetisation do not have to be applied directly adjacent to the starting material.

In a particularly advantageous configuration of the permanent magnet arrangement according to the disclosure, it is provided that a base surface of the permanent magnets has permanent magnet edges running obliquely to one another. In this way, in particular in the case of a ring-shaped configuration of the permanent magnet arrangement, the available magnetisable starting material can be magnetised to the greatest possible extent, such that a comparatively large magnetic flux density can be provided on the smallest possible area. A base surface of the permanent magnets can, for example, thereby be configured to be approximately trapezoidal in shape, with the inner and outer sides of the permanent magnets being configured to be curved and following the ring shape of the permanent magnet arrangement. As already explained above, the permanent magnet edges are determined by the magnetic flux density which is generated within the ring magnet by the permanent magnet and which drops to zero at the sides of the respective permanent magnet, with the side surfaces of the permanent magnet or the permanent magnet edges being predetermined by this drop to zero.

Advantageously, it is provided according to the disclosure that the permanent magnet edges have a curvature that increases continuously from an inner side facing the central axis to an outer side facing away from the central axis. It is known that during operation of axial flux machines, so-called cogging forces or cogging torques occur, which lead to increased noise and vibration during operation and reduce the overall efficiency of the machine. The cogging forces are magnetic interference forces and are caused by interactions between the permanent magnets and coil cores or stator teeth, which are made of iron or another material with good magnetic conductivity. In order to reduce these cogging forces, various measures are known from the prior art.

One of these measures is the so-called “bevelling of the magnet edges” of the permanent magnets. In this measure, the permanent magnets are adjusted starting from the approximately trapezoidal base surface such that the straight lines through the side edges no longer run through the axis of rotation or such that shapes deviating from the trapezoidal shape are selected, for example with bent side edges. One possibility known from the prior art for bevelling the magnet edges consists of adjusting the permanent magnets starting from the trapezoidal base surface such that the side edges are tilted by a so-called helix angle against the straight line running through the axis of rotation. The side edges of the permanent magnets thereby have the same displacement angle for each connection point on the respective side edge or at least for each connection point on sections of the side edges in the case of a bent course of the side edge. This is also called the helix angle.

In investigations with conventional permanent magnets with an approximately trapezoidal base surface with circular segment-shaped inner and outer edges, it has been shown that the contribution of individual sections of the permanent magnets to the cogging forces generated by these permanent magnets depends on the distance of the respective section from a machine axis or central axis of the axial flux machine. The configuration, according to the disclosure, of the permanent magnet edges utilises this knowledge to further reduce the cogging forces. For this purpose, instead of the configuration with a constant displacement or helix angle, the base surface of the permanent magnet or the permanent magnet edges are configured such that the opposite side surfaces have a continuously increasing or decreasing helix angle, with the helix angles being larger or smaller the greater the distance of the respective section of the permanent magnet from the machine axis and with the respective helix angle increasing or decreasing disproportionately depending on this distance.

Advantageously, it is provided according to the disclosure that the permanent magnet arrangement is made of a rare earth material. Advantageously, the material used can be, for example, neodymium-iron-boron or samarium-cobalt.

In order to protect the permanent magnet arrangement during operation of the axial flux machine, it is provided according to the disclosure that the permanent magnet arrangement has a coating to protect the permanent magnets. The coating can advantageously be, for example, a nickel-copper-nickel coating. According to the disclosure, this coating is only a few micrometres thick and advantageously less than 12 micrometres thick.

In order to improve the running properties of the axial flux machine when using the permanent magnet arrangement according to the disclosure, it is provided according to the disclosure that the permanent magnet arrangement has eight permanent magnets, advantageously twelve permanent magnets and particularly advantageously sixteen permanent magnets.

Advantageously, it is provided according to the disclosure that a ratio of a diameter of the permanent magnet arrangement to a thickness of the permanent magnet arrangement in the axial direction is at least twenty, advantageously at least thirty and particularly advantageously at least thirty-six. Such a configuration allows the permanent magnet arrangement to be made particularly flat, such that the installation space required for the arrangement of the permanent magnet arrangement in the axial flux machine can be reduced. Advantageously, a thickness of <1.1 to 6 mm is provided for a permanent magnet arrangement with a diameter of 40 to 120 mm.

The disclosure also relates to an axial flux machine with a coil arrangement and a permanent magnet arrangement as described above, with the coil arrangement having a plurality of electrical machine coils arranged adjacent to one another in a ring-shaped manner around the machine axis, with the coil arrangement being arranged axially displaced adjacent to the permanent magnet arrangement. Advantageously, the axial flux machine is a brushless axial flux machine. Such axial flux machines are particularly suitable for use with door or window drives

Advantageously, it is provided according to the disclosure that the inner ring circumference and the outer ring circumference of the permanent magnet arrangement correspond substantially to corresponding ring circumferences of the coil arrangement. In this way, a particularly compact design of the axial flux machine can be achieved.

The disclosure also relates to an electromechanical drive for actuating a leaf, in particular a door leaf or a window leaf, which is mounted rotatably and/or displaceably on a structural element, with an axial flux machine as described above

Advantageously, it is provided according to the disclosure that the electromechanical drive is a swing door leaf, sliding door or revolving door drive.

### BRIEF DESCRIPTION OF THE DRAWINGS

Further advantageous configurations of the method according to the disclosure and of the electromechanical drive according to the disclosure are explained in more detail with reference to exemplary embodiments represented in the drawing.

It shows:

FIGS. 1a and 1b schematically represented views of a permanent magnet arrangement according to the disclosure,

FIG. 2 schematically represented sectional view of an electromechanical drive in which the permanent magnet arrangement according to the disclosure is used, and

FIG. 3 schematically represented a top view of a permanent magnet arrangement according to the disclosure.

### DETAILED DESCRIPTION OF THE DRAWINGS

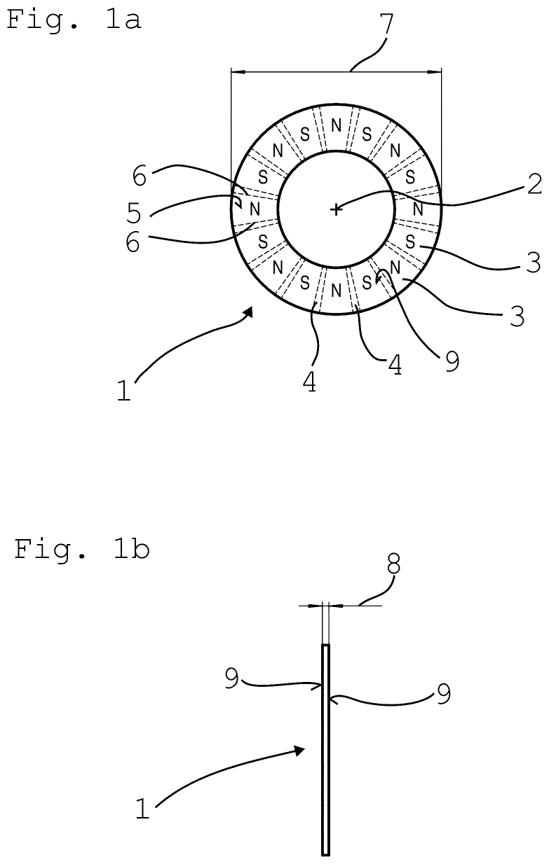

FIG. 1a shows a schematically represented top view and FIG. 1b a schematically represented side view of a permanent magnet arrangement 1 for use as a rotor or stator of an axial flux machine. The permanent magnet arrangement 1 has a plurality of permanent magnets 3 arranged in a ring-shaped manner around a central axis 2 and each magnetised in an axial direction running parallel to the central axis 2. An unmagnetised region 4 is provided between each two permanent magnets 3 arranged adjacent to one another, with the unmagnetised region 4 being configured in one piece with the permanent magnets 3. In the drawing, two permanent magnets 3 and two unmagnetised regions 4 are marked with a reference numeral as an example.

Permanent magnets 3 arranged adjacent to each other each have an opposite polarisation. This is indicated in FIG. 1a by the letters “N” for magnetic north pole and “S” for magnetic south pole. All permanent magnets 3 are configured in one piece and thus form a multi-pole pair ring magnet.

A base surface 5 of the permanent magnets 3 has permanent magnet edges 6 running obliquely to one another. In the drawing, a base surface 5 with two permanent magnet edges 6 is marked with a reference numeral as an example.

A diameter 7 of the permanent magnet arrangement 1 is between 40 and 120 mm. A thickness 8 of the permanent magnet arrangement 1 in the axial direction is between <1.1 to 6 mm. The ratio between diameter 7 and thickness 8 is approximately thirty-six. The permanent magnet arrangement 1 also has continuously flat surfaces 9.

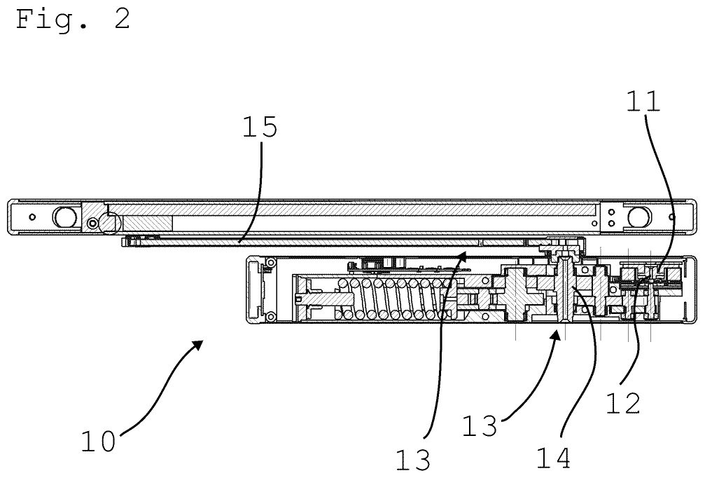

FIG. 2 schematically represents a sectional view of an electromechanical drive 10 for actuating a leaf, in particular a door leaf or a window leaf, which is mounted rotatably and/or displaceably on a structural element. The electromechanical drive 10 has an axial flux machine 11, which has, as a rotor, a permanent magnet arrangement according to the disclosure, not represented. A drive shaft 12 of the axial flux machine 11 is operatively connected to the leaf, not represented, via a power transmission device 13. The power transmission device 13 substantially comprises a gear 14 connected to the axial flux machine 11 and a lever 15. This converts a movement of the drive shaft 12 into a movement of the leaf.

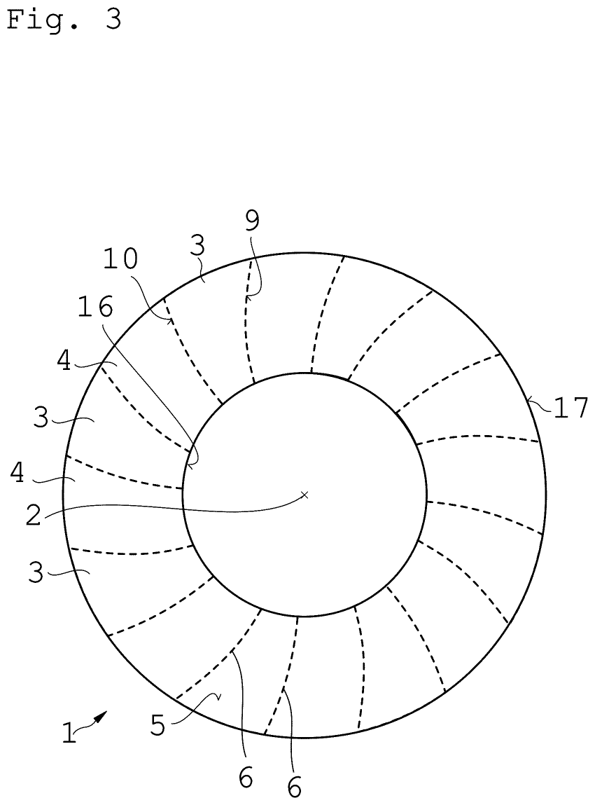

FIG. 3 shows a schematically represented top view of a permanent magnet arrangement 1 for use as a rotor or stator of an axial flux machine. The permanent magnet arrangement 1 has a plurality of permanent magnets 3 arranged in a ring-shaped manner around a central axis 2 and each magnetised in an axial direction running parallel to the central axis 2. An unmagnetised region 4 is provided between each two permanent magnets 3 arranged adjacent to one another, with the unmagnetised region 4 being configured in one piece with the permanent magnets 3. In the drawing, three permanent magnets 3 and two unmagnetised regions 4 are marked with a reference numeral as an example.

Permanent magnets 3 arranged adjacent to each other each have an opposite polarisation. All permanent magnets 3 are configured in one piece and thus form a multi-pole pair ring magnet.

A base surface 5 of the permanent magnets 3 has permanent magnet edges 6 running obliquely to one another, with the permanent magnet edges 6 having a curvature which increases continuously from an inner side 16 facing the central axis 2 to an outer side 17 facing away from the central axis 2. In the drawing, a base surface 5 with two permanent magnet edges 6 is marked with a reference numeral as an example.

1. A door drive comprising an axial flux machine with a permanent magnet arrangement for use as a rotor or a stator of an axial flux machine, wherein the permanent magnet arrangement has a plurality of permanent magnets arranged in a ring-shaped manner around a central axis and each magnetised in an axial direction running parallel to the central axis, and wherein permanent magnets arranged adjacent to one another each have an opposite polarisation, wherein at least two permanent magnets arranged adjacent to one another are configured in one piece.

2. The door drive according to claim 1, wherein all permanent magnets are configured in one piece with one another and form a multi-pole pair ring magnet.

3. The door drive according to claim 1, wherein an unmagnetised region is provided between each two permanent magnets arranged adjacent to one another, wherein the unmagnetised region is configured in one piece with the permanent magnets.

4. The door drive according to claim 1, wherein a base surface of the permanent magnets has permanent magnet edges running obliquely to one another.

5. The door drive according to claim 4, wherein the permanent magnet edges have a curvature that increases continuously from an inner side facing the central axis to an outer side facing away from the central axis.

7. The door drive according to claim 1, wherein the permanent magnet arrangement is made of a rare earth material.

8. The door drive according to claim 1, wherein the permanent magnet arrangement has a coating to protect the permanent magnets.

9. The door drive according to claim 1, wherein the permanent magnet arrangement has eight permanent magnets.

10. The door drive according to claim 1, wherein a ratio of a diameter of the permanent magnet arrangement to a thickness of the permanent magnet arrangement in the axial direction is at least twenty.

11. The door drive according to claim 1, wherein the axial flux machine comprises a coil arrangement and a permanent magnet arrangement, wherein the coil arrangement has a plurality of electrical machine coils arranged adjacent to one another in a ring-shaped manner around the machine axis, wherein the coil arrangement is arranged axially displaced adjacent to the permanent magnet arrangement.

12. (canceled)

13. The door drive according to claim 11, wherein the door drive is a swing door leaf or sliding door or revolving door drive.
